(19) United States
(12) Patent Application Publication
(10) Pub. No.: US 2026/0252701 A1
(43) Pub. Date: Aug. 27, 2026

(54) ANALYSIS ASSISTANCE DEVICE, STORAGE MEDIUM, AND ANALYSIS ASSISTANCE METHOD

(71) Applicant: Mitsubishi Electric Corporation, Chiyoda-Ku, Tokyo (JP)

(72) Inventors: Masaharu SHIOTANI, Tokyo (JP); Shigeto MIYAUCHI, Tokyo (JP); Shoji SAKURAI, Tokyo (JP)

(73) Assignee: Mitsubishi Electric Corporation, Chiyoda-Ku, Tokyo (JP)

(21) Appl. No.: 18/730,290

(22) PCT Filed: Mar. 14, 2023
(86) PCT No.: PCT/JP2023/009740

§ 371 Date: Jul. 18, 2024

(30) Foreign Application Priority Data
Apr. 8, 2022 (JP) 2022-064420

(51) Int. Cl. G06F 21/57

(52) U.S. Cl. CPC G06F 21/577

(57) ABSTRACT

The technique disclosed in the present specification is a technique for efficiently conducting dynamic analysis of a program. An analysis assistance device related to the technique disclosed in the present specification includes an expression specification unit configured to specify an expression condition of a vulnerability of the software, an operation specification unit configured to specify an operating condition, that is predetermined, for a program, an analysis unit configured to analyze whether the software is included in the program and output an analysis result, a conformance specification unit configured to specify a conformance condition that satisfies the expression condition, the operating condition, and the analysis result, and an output unit configured to output the conformance condition.

### TECHNICAL FIELD

The technique disclosed in the present specification relates to a technique for analysis assistance.

### BACKGROUND ART

In a conventional technique (for example, referring to Patent Document 1), development companies analyze the source code they manage to detect the potential usage of a function with vulnerability with respect to an input from external sources. Then, dynamic analysis is conducted on the source code as to whether a specific vulnerability pattern exists in the source code.

### PRIOR ART DOCUMENTS

### Patent Document(s)

[Patent Document 1] International Publication No.2006/087780

### SUMMARY

### Problem to be Solved by the Invention

If a vulnerability is discovered in the open source software (OSS) being utilized, at which point where a product has already been shipped to the market, the OSS is required to be updated. However, for products with wide-ranging impacts such as social infrastructure or products that are in constant operation, the OSS operation can be difficult to stop. Therefore, it is preferable that updating is only implemented when a vulnerability is expressed.

For whether a vulnerability is expressed, dynamic analysis of the program must be conducted to confirm that whether the vulnerability is expressed. However, a problem is posed, for example, in Patent Document 1, where a significant amount of time or cost is required to conduct dynamic analysis.

The technique disclosed in the present specification has been made in view of the problem described above, and is a technique for efficiently conducting dynamic analysis of the program.

### Means to Solve the Problem

An analysis assistance device of a first aspect disclosed in the present specification is an analysis assistance device configured to assist dynamic analysis of software. The analysis assistance device includes an expression specification unit configured to specify an expression condition of a vulnerability of the software, an operation specification unit configured to specify an operating condition, that is predetermined, for a program, an analysis unit configured to analyze whether the software is included in the program and output an analysis result, a conformance specification unit configured to specify a conformance condition that satisfies the expression condition, the operating condition, and the analysis result, and an output unit configured to output the conformance condition.

### Effects of the Invention

According to at least the first aspect of the technique disclosed in the present specification, by outputting the conformant condition that satisfies the expression condition, the operating condition, and the analysis result, dynamic analysis can be conducted efficiently under a condition under which a function with vulnerability is highly likely to be expressed.

The objects, characteristics, aspects, and advantages of the technique disclosed in the present specification of the present specification will become more apparent from the following detailed description and the accompanying drawings.

### BRIEF DESCRIPTION OF DRAWINGS

FIG. 1 A diagram conceptually illustrating an example of a configuration of an analysis assistance device according to Embodiment.

FIG. 2 A flowchart illustrating an example of an operation of the analysis assistance device according to Embodiment.

FIG. 3 A diagram illustrating an example of CVSS stored in a DB.

FIG. 4 A diagram conceptually illustrating an example of the state of software on a PC.

FIG. 5 A diagram illustrating an example of CVSS stored in the DB.

FIG. 6 A diagram illustrating an example of an operating condition stored in a DB.

FIG. 7 A diagram illustrating an example of an analysis result stored in the DB.

FIG. 8 A diagram schematically illustrating a hardware configuration when actually operating the analysis assistance device as illustrated in the drawings.

FIG. 9 A diagram schematically illustrating a hardware configuration when actually operating the analysis assistance device as illustrated in the drawings.

FIG. 10 A flowchart illustrating another example of the operation of the analysis assistance device according to Embodiment.

### DESCRIPTION OF EMBODIMENTS(S)

Hereinafter, Embodiments will be described with reference to the attached drawings. In following Embodiments, although detailed features and the like are also illustrated for technical explanation, they are mere examples, and not all the features to be described are essential for the implementation of Embodiments.

It should be noted that the drawings are schematically illustrated, and for the convenience of explanation, some omissions or simplifications of the configuration may be made in the drawings as appropriate. Also, the mutual relationship among sizes and positions in the configurations and the like illustrated in different drawings is not necessarily accurately described, and may be changed as appropriate. In addition, in the drawings such as plan views that are not cross-sectional views, hatching may be given to facilitate understanding of the contents of Embodiments.

In addition, in the following description, the same components are denoted by the same reference numerals, and the names and functions thereof are also similar. Accordingly, detailed descriptions thereof may be omitted to avoid redundancy.

Also, in the description stated in the specification of the present specification, when it is described that a certain component is “equipped”, “included”, or “an object has a certain component”, etc., such description is not exclusive expression that excludes the existence of other components unless specifically stated otherwise.

Also, in the description written in the specification of the present specification, even though ordinal numbers such as “first” and “second” may be used, these terms are for promoting the understanding of the contents and are not for defining the order caused by such ordinal numbers.

### Embodiment 1

Hereinafter, an analysis assistance device, an analysis assistance program, and an analysis assistance method according to Embodiment will be described.

### <Configuration of Analysis Assistance Device>

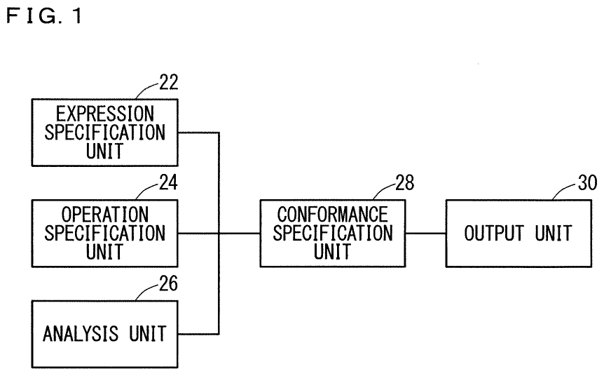

FIG. 1 is a diagram conceptually illustrating an example of a configuration of an analysis assistance device according to Embodiment. The analysis assistance device is a device that presents a condition under which a function with vulnerability is highly likely to be expressed to a dynamic analysis device prior to dynamic analysis of a product program conducted by the dynamic analysis device (not illustrated). Here, the product program is a program on which vulnerability analysis is conducted. As an example illustrated in FIG. 1, the analysis assistance device includes an expression specification unit 22, an operation specification unit 24, an analysis unit 26, a conformance specification unit 28, and an output unit 30.

The expression specification unit 22 is a functional unit that specifies an expression condition of a vulnerability of software. The operation specification unit 24 is a functional unit that specifies an operating condition, that is predetermined, for the product program. The analysis unit 26 is a functional unit that analyzes whether the software is included in the product program and outputs the analysis result.

The conformance specification unit 28 is a functional unit that specifies a conformance condition that satisfies the expression condition, the operating condition, and the analysis result. The output unit 30 is a functional unit that outputs the conformance condition. Details of the expression condition, the operating condition, the analysis result, and the conformance condition will be described later.

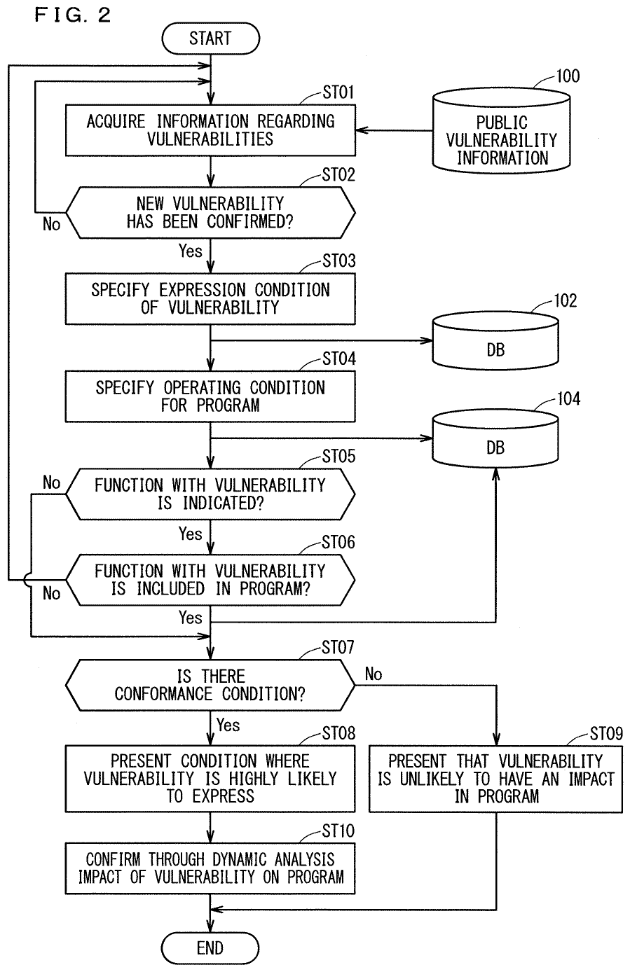

FIG. 2 is a flowchart illustrating an example of the operation of the analysis assistance device according to Embodiment.

First, in Step ST01, the expression specification unit 22 acquires, based on a list of OSS included in the product program that is stored in advance in the analysis assistance device, publicly available information regarding OSS vulnerabilities included in the list (public vulnerability information 100), from information sources such as CVE list, Japan Vulnerability Notes, or JVN iPedia.

Next, in Step ST02, the expression specification unit 22 determines whether a new vulnerability of the OSS has been confirmed based on the public vulnerability information 100. If a new vulnerability of the OSS is confirmed, that is, if it corresponds to “YES” branching from Step ST02, an example of which is illustrated in FIG. 2, the process proceeds to Step ST03, an example of which is illustrated in FIG. 2. On the other hand, if a new vulnerability of the OSS is not confirmed, that is, if it corresponds to “NO” branching from Step ST02, an example of which is illustrated in FIG. 2, the process returns to Step ST01, an example of which is illustrated in FIG. 2.

Such an operation can reduce the burden on a developer of constantly monitoring information regarding OSS vulnerabilities in the product program.

Note that the confirmation of a new vulnerability in Step ST02 determines whether a new vulnerability has been confirmed, regardless of whether a function with vulnerability is specifically indicated in the public vulnerability information 100.

Next, in Step ST03, the expression specification unit 22 specifies an expression condition of a vulnerability confirmed in Step ST02 (for example, a range of values to be input, a function name to be input, or a method of external input, etc.). Specifically, the expression specification unit 22 acquires a common vulnerability scoring system (CVSS) value assigned to each vulnerability from information regarding OSS vulnerabilities (public vulnerability information 100), and converts the value into a format that can be compared (comparison) with the operating condition for the product program. Further, the expression specification unit 22 stores the CVSS value whose format has been converted in a database (that is, DB) 102. Then, the process proceeds to Step ST04.

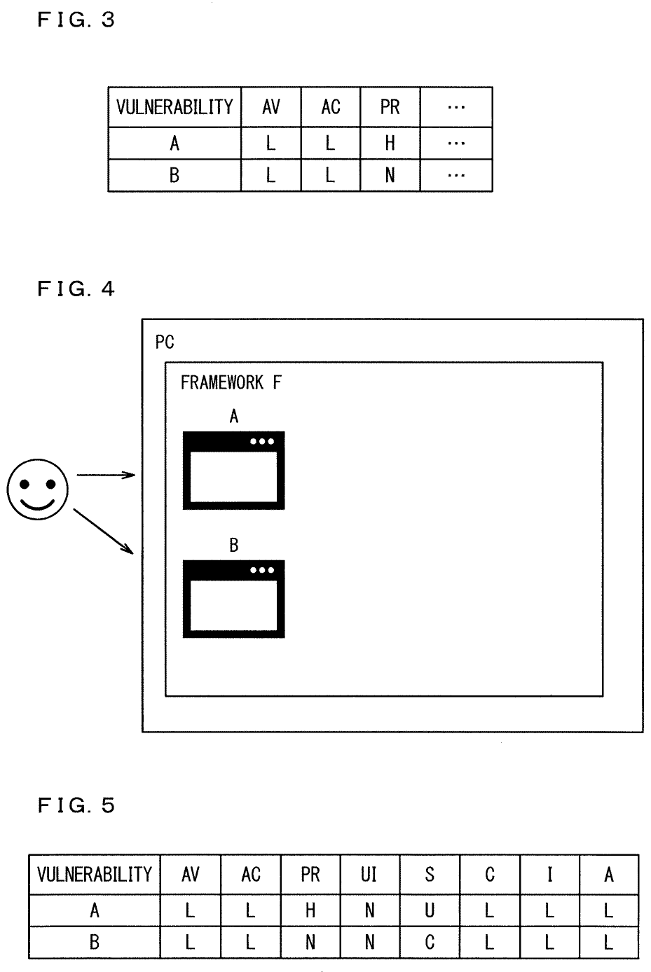

FIG. 3 is a diagram illustrating an example of CVSS stored in the DB 102. As the example illustrated in FIG. 3, in the DB 102, information is stored as one record for each piece of information regarding an OSS vulnerability. In FIG. 3, it is presented in the format of CVSS v3.

In FIG. 3, for the hypothetical vulnerability A, Attack vector (AV) being low (L), Attack complexity (AC) being low (L), and Privilege required (PR) level for attack being high (H) are indicated as one record. Also, for the hypothetical vulnerability B, Attack vector (AV) being low (L), Attack complexity (AC) being low (L), and Privilege required (PR) level for attack being none (N) are indicated as one record.

Next, in Step ST04 of FIG. 2, the operation specification unit 24 specifies the operating condition, that is predetermined, for the product program. The operating condition is input from the outside by, for example, a developer. The specified operating condition is stored in a DB 104.

Note that, if Step ST04 has already been executed, by retaining the previous state (input content), asking the developer whether to update the operating condition or the like, the input burden can be reduced.

Further, the developer can perform customization by inputting patterns of Base Metrics of CVSS, which are compared with a pattern of the operating condition when it is considered that the operating condition alone is not sufficient, and then, adding arbitrary operating conditions by inputting the method of determining an operating condition and an expression condition for the pattern.

Next, in Step ST05 of FIG. 2, the analysis unit 26 analyzes whether a function with vulnerability is indicated in the public vulnerability information 100. If the function with vulnerability is indicated, that is, if it corresponds to “YES” branching from Step ST05, an example of which is illustrated in FIG. 2, the process proceeds to Step ST06, an example of which is illustrated in FIG. 2. On the other hand, if the function with vulnerability is not indicated, that is, if it corresponds to “NO” branching from Step ST05, an example of which is illustrated in FIG. 2, the process proceeds to Step ST07, an example of which is illustrated in FIG. 2.

Next, in Step ST06 of FIG. 2, the analysis unit 26 statically analyzes whether the function with vulnerability acquired in Step ST05 is included in the product program. Specifically, a static analysis is conducted in which an input is the name of the function with vulnerability and an output is whether the function is included in the product program. And if the function with vulnerability is included in the product program, that is, if it corresponds to “YES” branching from Step ST06, an example of which is illustrated in FIG. 2, the process proceeds to Step ST07, an example of which is illustrated in FIG. 2, while storing the analysis result (including the input range of the function) in the DB 104. On the other hand, if the function with vulnerability is not included in the product program, that is, if it corresponds to “NO” branching from Step ST06, an example of which is illustrated in FIG. 2, the process returns to Step ST01, an example of which is illustrated in FIG. 2.

In Step ST07 of FIG. 2, the conformance specification unit 28 determines whether a condition under which the vulnerability is likely to be expressed (that is, conformance condition) in the product program is there by comparing the expression condition stored in the DB 102 in Step ST03, the operating condition stored in the DB 104 in Step ST04, and the analysis result stored in the DB 104 in Step ST06. Note that if the function with vulnerability is not indicated in Step ST05, whether the conformance condition is there is determined by comparing the expression condition and the operating condition among the above.

For example, “YES or NO” is input as a description example for the operating condition of “whether connected to an external network” and “Attack Vector” is compared as the expression condition (CVSS).

Alternatively, “YES or NO” is input as a description example for the operating condition of “whether connected to a local network” and “Attack Vector” is compared as the expression condition (CVSS).

Alternatively, “High (administrator privileges) or Low (user privileges)” is input as a description example for the operating condition of “what privileges are required to operate?” and “Privileges Required” is compared as the expression condition (CVSS).

Alternatively, “YES or NO” is input as a description example for the operating condition of “authentication required?” and “Privileges Required” is compared as the expression condition (CVSS).

Alternatively, “YES or NO” is input as a description example for the operating condition of “can external devices such as USB be inserted?” and “Attack Vector, User Interaction, or Attack Complexity” is compared as the expression condition (CVSS).

Alternatively, “malicious user or trusted user” is input as a description example for the operating condition of “what type of user will operate?” and “User Interaction” is compared as the expression condition (CVSS).

Alternatively, “YES or NO” is input as a description example for the operating condition of “can be analyzed externally using electromagnetic wave analysis, etc. ? ” and “Attack Vector, User Interaction, or Attack Complexity” is compared as the expression condition (CVSS).

Alternatively, “Windows 10 (registered trademark), Ubuntu (registered trademark), or Mac (registered trademark)” is input as a description example for the operating condition of “which operating system (OS) is executed?” and “Attack Complexity” is compared as the expression condition (CVSS).

Alternatively, “YES or NO” is input as a description example for the operating condition of “can a human operates the product program in the operating environment?” and “User Interaction” is compared as the expression condition (CVSS).

Alternatively, “YES or NO” is input as a description example for the operating condition of “is there an input from an external interface (that is, IF)?” and “Attack Complexity or Attack Vector” is compared as the expression condition (CVSS).

Alternatively, “started by a human, automatically started, or constantly running” is input as a description example for the operating condition of “product program startup method” and “User Interaction or Attack Complexity” is compared as the expression condition (CVSS).

Alternatively, for the operating condition of “the range of input values from the external IF”, “alphabet or numerical values”, as a description example thereof, is compared.

Alternatively, “input from network, no input, or mechanically input only a specific value” is input as a description example for the operating condition of “input method from the external IF” and “Attack Vector” is compared as the expression condition (CVSS).

Then, if there is a condition under which a function with vulnerability is highly likely to be expressed, that is, if it corresponds to “YES” branching from Step ST07, an example of which is illustrated in FIG. 2, the process proceeds to Step ST08, an example of which is illustrated in FIG. 2, while specifying the condition under which a vulnerability is highly likely to be expressed. On the other hand, if there is not a condition under which a function with vulnerability is highly likely to be expressed, that is, if it corresponds to “NO” branching from Step ST07, an example of which is illustrated in FIG. 2, the process proceeds to Step ST09, an example of which is illustrated in FIG. 2.

In Step ST08 of FIG. 2, the output unit 30 generates a data set and a proof of concept (POC) program in which the vulnerability is highly likely to be expressed. By using the data set and the POC program, dynamic analysis can be conducted automatically or efficiently, enabling the confirmation of the actual impact of the vulnerability. Further, the output unit 30 presents the condition under which a vulnerability is highly likely to be expressed specified in Step ST07. Then, the process proceeds to Step ST10, an example of which is illustrated in FIG. 2.

In Step ST09 of FIG. 2, the output unit 30 generates a data set and the POC program that cover the conditions under which a vulnerability expresses. By using the data set and the POC program, dynamic analysis can be conducted automatically or efficiently, enabling the confirmation of no impacts of the vulnerabilities. The output unit 30 also presents that the newly discovered vulnerability is unlikely to have an impact in the product program. Then, the operation ends.

In Step ST10, the dynamic analysis device confirms, through dynamic analysis, the impact of the newly discovered vulnerability on the product program under the condition specified in Step ST07. Then, the operation ends.

This operation allows developers to know whether there is a condition under which a function with vulnerability is highly likely to be expressed, so the developers can efficiently conduct dynamic analysis limited to those conditions. Therefore, the time or cost required for dynamic analysis of the product program can be reduced.

### Embodiment 2

An analysis assistance device, an analysis assistance program, and an analysis assistance method according to Embodiment will be described. In the following description, components similar to those described in Embodiment described above are denoted by the same reference numerals, and detailed description thereof will be omitted as appropriate.

### <Configuration of Analysis Assistance Device>

In Embodiment, a case of a product program on which manual input is performed from the outside using a PC will be described with reference to FIG. 4. FIG. 4 is a diagram conceptually illustrating an example of the state of software (function) on a PC.

The operation of the product program according to Embodiment is implemented on the PC without connecting to an external network. Further, in the product program according to Embodiment, it is assumed that a predetermined open source framework F is used, and a predetermined function A and a predetermined function B are used.

The function A expresses a vulnerability thereof when it has administrative privileges and receives a specific input “XXX”. It is assumed that when a vulnerability is expressed in function A, information leaks to the outside.

The function B expresses a vulnerability thereof when it does not have privileges and receives a specific input “YYY”. It is assumed that when a vulnerability is expressed in function B, the configuration file is rewritten”.

It is assumed that vulnerabilities generate in the function A and the function B at a certain timing. In that case, first, similar to Step ST03 in FIG. 2, the expression conditions of vulnerabilities that have been generated are specified. Specifically, the expression specification unit 22 converts a CVSS value assigned to each vulnerability into a format that can be compared with the operating condition for the product program. Further, the expression specification unit 22 stores the CVSS value whose format has been converted in the DB 102.

FIG. 5 is a diagram illustrating an example of CVSS stored in the DB 102. As the example illustrated in FIG. 5, in the DB 102, information is stored as one record for each piece of information regarding an OSS vulnerability. In FIG. 5, it is presented in the format of CVSS v3.

In FIG. 5, for the function A, Attack vector (AV) being low (L), Attack complexity (AC) being low (L), Privilege required (PR) level for attack being high (H), User involvement (UI) being none (N), Scope of impact(S) being unchanged (U), Confidentiality impact (C) being low (L), Integrity impact (I) being low (L), and Availability impact (A) being low (L) are indicated as one record. Further, for the function B, Attack vector (AV) being low (L), Attack complexity (AC) being low (L), Privilege required (PR) level for attack being none (N), User involvement (UI) being none (N), Scope of impact(S) being changed (C), Confidentiality impact (C) being low (L), Integrity impact (I) being low (L), Availability impact (A) being low (L) are indicated as one record.

Here, regardless of Embodiments, when dynamic analysis is conducted on whether vulnerabilities are expressed in the function A and the function B, it is necessary to execute all input patterns of the function A with administrator privileges, and all input patterns of function B with arbitrary privileges.

Next, similar to Step ST04 in FIG. 2, the operating condition, that is predetermined, for the product program is specified by the operation specification unit 24 and then, the specified operating condition is stored in the DB 104.

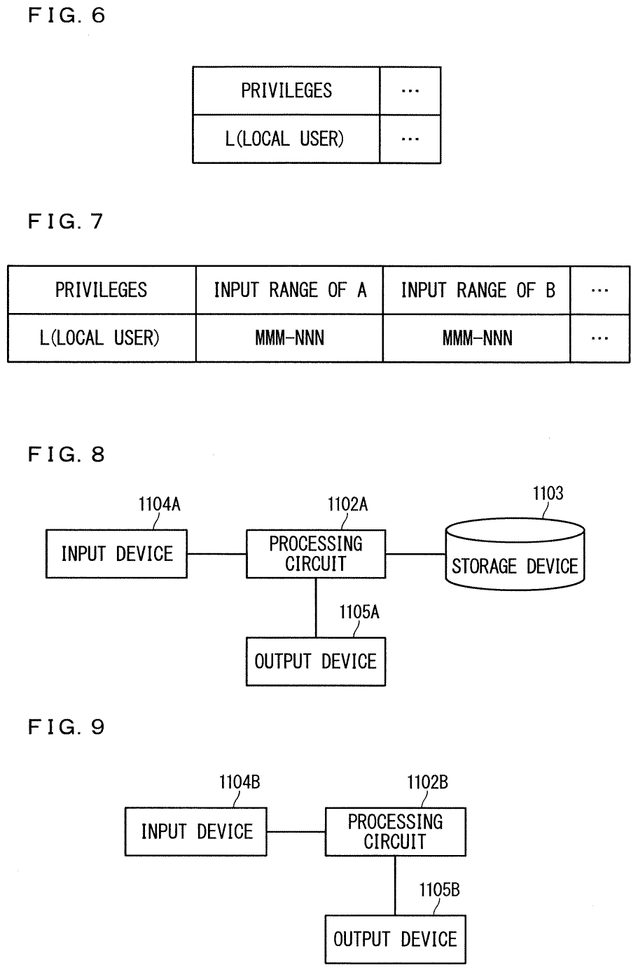

FIG. 6 is a diagram illustrating an example of the operating condition stored in the DB 104. As the example illustrated in FIG. 6, it is assumed that the product program in Embodiment is executed only by a specific user (local user) who does not have administrator privileges. It is assumed that privileges (operating conditions) take either the value L or the value H, where L indicates execution by a user without administrator privileges (local users), and H indicates execution by a user with administrator privileges.

Next, similar to Step ST05 in FIG. 2, the analysis unit 26 analyzes whether the function A and the function B are included in the product program. Then, the analysis result (including the input range of the function) is stored in the DB 104.

FIG. 7 is a diagram illustrating an example of the analysis result stored in the DB 104. As the example illustrated in FIG. 7, it is assumed that the function A and the function B in the product program are executed only by a specific user (local user) who does not have administrator privileges. It is also illustrated that the input range of the function A is from MMM to NNN, and the input range of the function B is from MMM to NNN.

Next, similar to Step ST06 in FIG. 2, the conformance specification unit 28 determines whether there is a condition under which the vulnerabilities of the function A and the function B are highly likely to be expressed in the product program by comparing (comparison) the expression condition stored in DB 102, the operating condition stored in DB 104, and the analysis result stored in DB 104. For example, compare the item of privileges in FIG. 7 with the items of Privilege required (PR) level for attack in FIG. 5.

First, comparison of the function A will be described. The condition under which a vulnerability of the function A is to be expressed includes that it is executed with administrator privileges. Meanwhile, the product program according to Embodiment is executed only by a specific user (local user) who does not have administrator privileges. This indicates that the Privilege required (PR) level for attack of the function A illustrated in FIG. 5 is high (H), whereas the privileges (operating condition) of the product program illustrated in FIG. 7 is a local user (L).

Therefore, the operating condition for the product program do not satisfy the expression condition of the vulnerability of the function A; therefore, there is not a condition under which the vulnerability of the function A is highly likely to be expressed.

Next, comparison of the function B will be described. The condition under which a vulnerability of the function B is to be expressed includes that it is executed with arbitrary user privileges. Meanwhile, the product program of Embodiment is executed only by a specific user (local user) who does not have administrator privileges. This indicates that the Privilege required (PR) level for attack of the function B illustrated in FIG. 5 is none (N), whereas the privileges (operating condition) of the product program illustrated in FIG. 7 is a local user (L).

Therefore, the operating condition for the product program satisfies the expression condition of the vulnerability of the function B; therefore, there is a condition under which the vulnerability of the function B is highly likely to be expressed. Specifically, the function B has a condition under which the vulnerability is highly likely to be expressed in an input range from MMM to NNN.

Here, it is determined whether the specific input “YYY” included in the expression condition of the function B is included in the input range from MMM to NNN. Then, if the specific input “YYY” is included in the input range from MMM to NNN, the condition under which the vulnerability of the function B is highly likely to be expressed is ultimately specified as “input the value of YYY when executing the normal product program”.

Next, similar to Step ST07 in FIG. 2, the output unit 30 presents the condition under which the vulnerability of the function B is likely to be expressed. Specifically, it presents the condition that “input the value of YYY when executing a normal product program”.

As a result, comparing with the case where dynamic analysis is conducted for whether the vulnerabilities of the function A and the function B are to be expressed without using the method illustrated in Embodiment, when conducting dynamic analysis of the product program, analysis of the input pattern of the function A and analysis of the input pattern YYY of the function B can be omitted. Therefore, dynamic analysis can be conducted efficiently.

### <Hardware Configuration of Analysis Assistance Device>

FIGS. 8 and 9 are diagrams schematically illustrating hardware configurations when actually operating the analysis assistance device as illustrated in FIG. 1.

It should be noted that the hardware configurations illustrated in FIGS. 8 and 9 may not coincide with the configuration illustrated in FIG. 1 in terms of numbers of components or the like, this is because the configuration illustrated in FIG. 1 illustrates conceptual units.

Thus, there may be assumed a case where at least if one configuration illustrated in FIG. 1 composed of a plurality of hardware configurations illustrated in FIGS. 8 and 9, a case where one configuration illustrated in FIG. 1 corresponds to part of the hardware configuration illustrated in FIGS. 8 and 9, and further, a case where a plurality of configurations illustrated in FIG. 1 are provided in one hardware configuration illustrated in FIGS. 8 and 9.

In FIG. 8, as a hardware configuration for implementing the expression specification unit 22, the operation specification unit 24, the analysis unit 26, the conformance specification unit 28, and the like, in FIG. 1, a processing circuit 1102A that performs calculations, a storage device 1103 that can store information, an input device 1104A that can input information, such as a mouse, a keyboard, a touch panel, or various switches, and an output device 1105A (including the case where it is shared with the input device 1104A) that can output information, such as a display, a liquid crystal display device, or a lamp, are illustrated. The configuration also applies to any of the other Embodiments above.

In FIG. 9, as a hardware configuration for implementing the expression specification unit 22, the operation specification unit 24, the analysis unit 26, the conformance specification unit 28, and the like, in FIG. 1, a processing circuit 1102B that performs calculations, an input device 1104B that can input information, such as a mouse, a keyboard, a touch panel, or various switches, and an output device 1105B (including the case where it is shared with the input device 1104B) that can output information, such as a display, a liquid crystal display device, or a lamp, are illustrated. The configuration also applies to any of the other Embodiments above.

The DB 102 and the DB 104 are implemented by the storage device 1103 or another storage device (not illustrated here).

The storage device 1103 may be, for example, a volatile or non-volatile semiconductor memory, such as a hard disk drive (HDD), a random access memory (RAM), a read only memory (ROM), a flash memory, an erasable programmable read only memory (EPROM), an electrically erasable programmable read-only memory, (EEPROM), or the like, or a memory (storage medium) including a magnetic disk, a flexible disk, an optical disk, a compact disk, a mini disk, or a DVD, or any storage medium used in the future.

The processing circuit 1102A may execute a program stored in the storage device 1103, an external CD-ROM, an external DVD-ROM, or an external flash memory. That is, for example, a central processing unit (CPU), a microprocessor, a microcomputer, a digital signal processor (DSP) may also be adoptable therefor.

When the processing circuit 1102A executes a program stored in the storage device 1103, an external CD-ROM, an external DVD-ROM, or an external flash memory, the expression specification unit 22, the operation specification unit 24, the analysis unit 26, and the conformance specification unit 28 are implemented by software, firmware, or a combination of software and firmware in which a program stored in the storage device 1103 is executed by the processing circuit 1102A. Note that the functions of the expression specification unit 22, the operation specification unit 24, the analysis unit 26, and the conformance specification unit 28 may be implemented through, for example, collaboration of a plurality of processing circuits.

Software and firmware may be written as programs and stored in the storage device 1103. In that case, the processing circuit 1102A reads out and executes the programs stored in the storage device 1103 to implement the above functions. That is, the storage device 1103 may store a program that, when executed by the processing circuit 1102A, implements the above functions ultimately.

Also, the processing circuit 1102B may be dedicated hardware. That is, for example, a single circuit, a composite circuit, a programmed processor, a parallel programmed processor, an application specific integrated circuit (i.e., ASIC), a field-programmable gate array (FPGA), or a combination thereof may also be adoptable.

When the processing circuit 1102B is dedicated hardware, the expression specification unit 22, the operation specification unit 24, the analysis unit 26, and the conformance specification unit 28 are implemented by the operation of the processing circuit 1102B. Note that the functions of the expression specification unit 22, the operation specification unit 24, the analysis unit 26, and the conformance specification unit 28 may be implemented with individual circuits, or be implemented with a single circuit.

The functions of the expression specification unit 22, the operation specification unit 24, the analysis unit 26, and the conformance specification unit 28 are partly implemented by the processing circuit 1102A that executes the program stored in the storage device 1103, and partly by the processing circuit 1102B being dedicated hardware.

### <Effect Produced by Embodiments Described Above>

Next, an example of effect produced by Embodiments described above is illustrated. In the following description, although the effect will be described based on the specific configuration exemplified in Embodiments described above, the specific configuration may be replaced with other specific configurations exemplified in the specification of the present specification as long as the similar effect is produced. That is, hereinafter, for convenience, although a sole specific configuration of the associated specific configurations may be described as a representative, the specific configuration may also be replaced with the other specific configurations to which the representatively described specific configuration.

Also, the replacement may be made across a plurality of Embodiments. In other words, the replacement may also be a case where the respective configurations whose examples are illustrated in different Embodiments are combined to produce the same effect.

According to Embodiments described above, the analysis assistance device includes the expression specification unit 22, the operation specification unit 24, the analysis unit 26, the conformance specification unit 28, and the output unit 30. The expression specification unit 22 specifies the expression condition of a vulnerability of software. The operation specification unit 24 specifies the operating condition, that is predetermined, for the program. The analysis unit 26 analyzes whether the software is included in the program and outputs the analysis result. The conformance specification unit 28 specifies the conformance condition that satisfies the expression condition, the operating condition, and the analysis result. The output unit 30 is a functional unit that outputs the Conformance Condition.

Also, according to Embodiments described above, the analysis assistance device includes the processing circuit 1102A that executes the program, and the storage device 1103 that stores the program to be executed. The following operation is implemented by the processing circuit 1102A executing the program.

That is, the expression condition of the vulnerability of the software is specified, the operating condition, that is predetermined, for the program is specified, whether the software is included in the program is analyzed and the analysis result is output, and the conformance condition that satisfies the expression condition, the operating condition, and the analysis result is specified, and the conformance condition is output.

Also, according to Embodiments described above, the analysis assistance device includes the processing circuit 1102B being dedicated hardware. The processing circuit 1102B being dedicated hardware, performs the following operation.

That is, the processing circuit 1102B being dedicated hardware specifies the expression condition of a vulnerability of the software, specifies the operating condition, that is predetermined, for the program, analyzes whether the software is included in the program and outputs the analysis result, and specifies the conformance condition that satisfies the expression condition, the operating condition, and the analysis result, and outputs the conformance condition.

According to such a configuration, by outputting the conformant condition that satisfies the expression condition, the operating condition, and the analysis result, dynamic analysis of the program can be conducted efficiently under a condition under which a function with vulnerability is highly likely to be expressed. Therefore, the time or cost required for dynamic analysis of the program can be reduced.

It should be noted that, even when other configurations whose examples are illustrated in the present specification are added to the above configurations as appropriate, that is, when other configurations in the present specification that are not mentioned as the above configurations are added as appropriate can produce a similar effect.

Further, according to Embodiments described above, the expression specification unit 22 specifies the expression condition of a vulnerability based on the information regarding the vulnerability of the software that is publicly available. The expression condition is then specified based on the CVSS value assigned to each vulnerability. According to such a configuration, by acquiring the latest information regarding vulnerabilities by acquiring publicly available information regarding OSS vulnerabilities (public vulnerability information 100) from information sources such as CVE list, Japan Vulnerability Notes, or JVN iPedia, and converting the expression condition to a format that can be comparable with the operating condition based on CVSS values, the conformance condition can be easily specified.

Further, according to Embodiments described above, the conformant specification unit 28 specifies the conformance condition, for the software that indicates that the analysis result is included in the program, by comparing the expression condition with the operating condition. According to such a configuration, the conformant condition can be specified efficiently only for the software included in the program.

Further, according to Embodiments described above, the expression specification unit 22 specifies whether the expression condition is included within the input range of the software. According to such a configuration, the expression condition can be reliably specified with the input range of the software being considered.

According to Embodiments described above, the analysis assistance program causes the computer to specify the expression condition of a vulnerability of software. Then it causes the computer to specify an operating condition, that is predetermined, for the program. Then it causes the computer to analyze whether the software is included in the program and output the analysis result. Then it causes the computer to specify the conformance condition that satisfies the expression condition, the operating condition, and the analysis result. Then, it causes the computer to output the conformance condition.

According to such a configuration, by outputting the conformant condition that satisfies the expression condition, the operating condition, and the analysis result, dynamic analysis can be conducted efficiently under a condition under which a function with vulnerability is highly likely to be expressed.

It should be noted that, even when at least one of other configurations whose examples are illustrated in the present specification is added to the above configurations as appropriate, when other configurations in the present specification whose examples are illustrated that are not mentioned as the above configurations are added as appropriate, the similar effect can be produced.

Also, the above program may be recorded on a computer-readable portable storage medium such as a magnetic disk, a flexible disk, an optical disk, a compact disk, a Blu-ray disk (registered trademark), or a DVD. A portable recording medium on which a program that implements the above functions is recorded may be commercially distributed.

Further, according to Embodiments described above, making the conformant condition specified is making the conformance condition specified, for the software that indicates that the analysis result is included in the program, by comparing the expression condition with the operating condition. According to such a configuration, the conformant condition can be specified efficiently only for the software included in the

According to Embodiments described above, in the analysis assistance method, the expression condition of a vulnerability of the software is specified. Then, the operating condition, that is predetermined, for the program is specified. Then, whether the software is included in the program is analyzed and the analysis result is output. Then, the conformance condition that satisfies the expression condition, the operating condition, and the analysis result is specified. And, the conformance condition is output.

According to such a configuration, by outputting the conformant condition that satisfies the expression condition, the operating condition, and the analysis result, dynamic analysis can be conducted efficiently under a condition under which a function with vulnerability is highly likely to be expressed.

Note that the order in which each process is performed can be changed unless otherwise specified.

In addition, even when other configurations whose examples are illustrated in the present specification are added to the above configurations as appropriate, that is, when other configurations in the present specification that are not mentioned as the above configurations are added as appropriate, the similar effect can be produced.

Further, according to Embodiments described above, specifying the conformant condition is specifying the conformance condition, for the software that indicates that the analysis result is included in the program, by comparing the expression condition with the operating condition. According to such a configuration, the conformant condition can be specified efficiently only for the software included in the program.

### <Modification of Embodiments Described Above>

In Embodiments described above, although the dimensions, shape, relative arrangement relationship, implementation conditions, etc. of each component may be described, these elements are mere examples in all aspects, and shall not be limiting thereof.

Thus, it is understood that numerous other modification examples and equivalents not having been described can be devised without departing from the scope of the technique disclosed in the present specification. For example, a case where at least one component is modified, a case where components are added or omitted, and further, a case where at least one component is extracted from at least one Embodiment and combined it with a component of another Embodiment are included.

Further, “one or more” components may be included when described that “one” component is provided in Embodiments described above, so far as consistent with Embodiments.

Furthermore, each component in Embodiments described above is a conceptual unit, and within the scope of the technique disclosed in the present specification, a case where one component is composed of a plurality of structures, a case where one component corresponds to a part of a structure, and further, a case where a plurality of components are provided in one structure are included.

Further, each component in Embodiments described above includes a structure having another structure or shape as long as the same function is exhibited.

Each component described in Embodiments described above is also assumed as software or firmware, as well as corresponding hardware, and each component is referred to as a “unit” or the like, as software, and “circuitry” or the like, as hardware.

Further, the technique disclosed in the present specification, when each component is distributed in a plurality of devices, specifically, a form of a system as a combination of a plurality of devices may be adoptable.

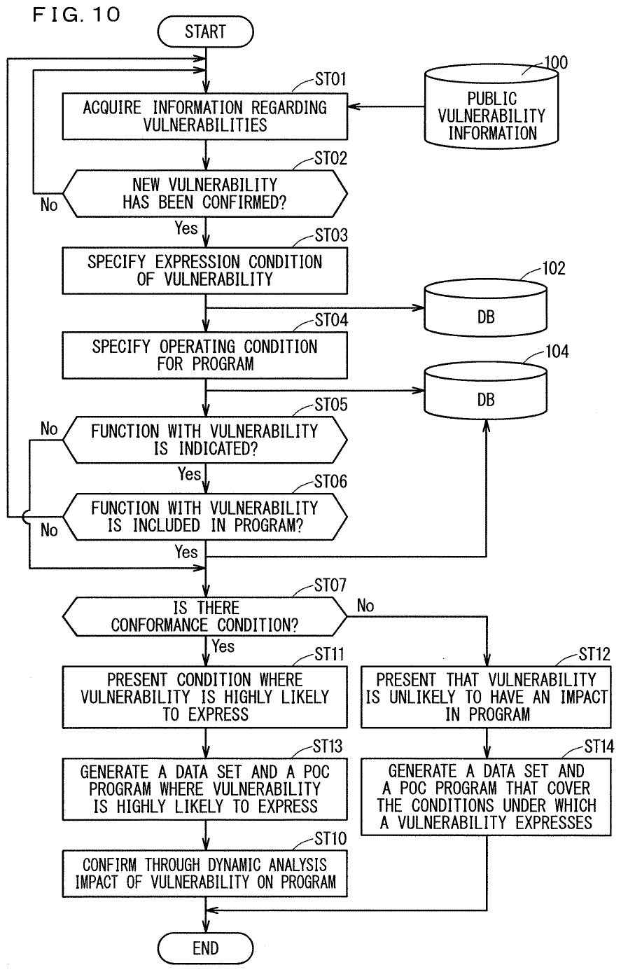

FIG. 10 is a flowchart illustrating another example of the operation of the analysis assistance device according to Embodiment. Steps ST01 to ST07 illustrated in FIG. 10 are the same as those illustrated in FIG. 2.

In ST11 of FIG. 10, the output unit 30 presents the condition under which a vulnerability is highly likely to be expressed specified in Step ST07. Then, the process proceeds to Step ST13, an example of which is illustrated in FIG. 10.

In Step ST13 of FIG. 10, the output unit 30 generates a data set and a POC program (RPA, no-code, etc.) in which a function with vulnerability is highly likely to be expressed. By using the data set and the POC program, dynamic analysis can be conducted automatically or efficiently, enabling the confirmation of the actual impact of the vulnerability. Then, the process proceeds to Step ST10, an example of which is illustrated in FIG. 10.

Meanwhile, in Step ST12 of FIG. 10, the output unit 30 presents that the newly discovered vulnerability is unlikely to have an impact in the product program. Then, the process proceeds to Step ST14, an example of which is illustrated in FIG. 10.

In Step ST14 of FIG. 10, the output unit 30 generates a data set and a POC program (RPA, no-code, etc.) that covers the conditions under which a vulnerability expresses. By using the data set and the POC program, dynamic analysis can be conducted automatically or efficiently, enabling the confirmation of no impacts of the vulnerabilities. Then, the process proceeds to Step ST10, an example of which is illustrated in FIG. 10.

In Step ST10, the dynamic analysis device confirms through dynamic analysis the impact of the newly discovered vulnerability on the product program under the condition specified in Step ST07. Then, the operation ends.

Hereinafter, various aspects of the present disclosure will be collectively described as Appendices.

### (Appendix 1)

An analysis assistance device configured to assist dynamic analysis of software, comprising:
an expression specification unit configured to specify an expression condition of a vulnerability of the software;
an operation specification unit configured to specify an operating condition, that is predetermined, for a program;
an analysis unit configured to analyze whether the software is included in the program and output an analysis result;
a conformance specification unit configured to specify a conformance condition that satisfies the expression condition, the operating condition, and the analysis result; and
an output unit configured to output the conformance condition.

### (Appendix 2)

The analysis assistance device according to Appendix 1, wherein
the expression specification unit specifies the expression condition of the vulnerability based on information regarding the vulnerability of the software that is publicly available, and
the expression condition is specified based on a CVSS value assigned to each of the vulnerabilities.

### (Appendix 3)

The analysis assistance device according to Appendix 1 or 2, wherein the conformance specification unit specifies the conformance condition, for the software that indicates that the analysis result is included in the program, by comparing the expression condition with the operating condition.

### (Appendix 4)

The analysis assistance device according to any one of Appendices 1 to 3,wherein
the expression specification unit specifies whether the expression condition is included within an input range of the software.

### (Appendix 5)

An analysis assistance program having a plurality of instructions executable by a computer, executed by one or a plurality of processors, to assist dynamic analysis of software, wherein,
the plurality of instructions executed by the processors cause
the computer to specify an expression condition of a vulnerability of the software,
the computer to specify an operating condition, that is predetermined, for a program,
the computer to analyze whether the software is included in the program and output an analysis result,
the computer to specify a conformance condition that satisfies the expression condition, the operating condition, and the analysis result, and
the computer to output a program capable of reproducing the conformance condition and a data set including the conformance condition, or a program and a data set covering the expression condition of a vulnerability.

### (Appendix 6)

The analysis assistance program according to Appendix 5, wherein
making the conformant condition specified is making the conformance condition specified, for the software that indicates that the analysis result is included in the program, by comparing the expression condition with the operating condition.

### (Appendix 7)

An analysis assistance method of assisting dynamic analysis of software, comprising:
specifying an expression condition of a vulnerability of the software;
specifying an operating condition, that is specified, for a program;
analyzing whether the software is included in the program and outputting the analysis result;
specifying a conformance condition that satisfies the expression condition, the operating condition, and the analysis result; and
outputting the conformance condition.

### (Appendix 8)

The analysis assistance method according to Appendix 7, wherein
specifying the conformant condition is specifying the conformance condition, for the software that indicates that the analysis result is included in the program, by comparing the expression condition with the operating condition.

### EXPLANATION OF REFERENCE SIGNS

22 expression specification unit, 24 operation specification unit, 26 analysis unit, 28 conformance specification unit, 30 output unit.

1. An analysis assistance device configured to assist dynamic analysis of software, comprising:
at least one processor to execute a program; and
at least one memory to store the program which, when it is executed by the processor, performs processes of:
specifying an expression condition of a vulnerability of the software;
specifying an operating condition, that is predetermined, for a program;
analyzing whether the software is included in the program and output an analysis result;
a specifying a conformance condition that satisfies the expression condition, the operating condition, and the analysis result; and
outputting the conformance condition.

2. The analysis assistance device according to claim 1, wherein
the expression condition of the vulnerability is specified based on information regarding the vulnerability of the software that is publicly available, and
the expression condition is specified based on a CVSS value assigned to each of the vulnerabilities.

3. The analysis assistance device according to claim 1, wherein
the conformance condition, for the software that indicates that the analysis result is included in the program, is specified by comparing the expression condition with the operating condition.

4. The analysis assistance device according to claim 1, wherein
it is further specified whether the expression condition is included within an input range of the software.

5. A storage medium having stored thereupon program comprising a plurality of computer executable instructions for execution by at least one processor, the plurality of computer executable instructions for assistance of dynamic analysis of software, comprising:
making the computer specify an expression condition of a vulnerability of the software,
making the computer specify an operating condition, that is predetermined, for a program,
making the computer analyze whether the software is included in the program and output an analysis result,
making the computer specify a conformance condition that satisfies the expression condition, the operating condition, and the analysis result, and
making the computer output a program capable of reproducing the conformance condition and a data set including the conformance condition, or a program and a data set covering the expression condition of a vulnerability.

6. The storage medium according to claim 5, wherein
making the conformant condition specified is making the conformance condition specified, for the software that indicates that the analysis result is included in the program, by comparing the expression condition with the operating condition.

7. An analysis assistance method of assisting dynamic analysis of software, comprising:
specifying an expression condition of a vulnerability of the software;
specifying an operating condition, that is specified, for a program;
analyzing whether the software is included in the program and outputting the analysis result;
specifying a conformance condition that satisfies the expression condition, the operating condition, and the analysis result; and
outputting the conformance condition.

8. The analysis assistance method according to claim 7, wherein
specifying the conformant condition is specifying the conformance condition, for the software that indicates that the analysis result is included in the program, by comparing the expression condition with the operating condition.

9. The analysis assistance device according to claim 2, wherein
the conformance condition, for the software that indicates that the analysis result is included in the program, is specified by comparing the expression condition with the operating condition.

10. The analysis assistance device according to claim 2, wherein
it is further specified whether the expression condition is included within an input range of the software.

11. The analysis assistance device according to claim 3, wherein
it is further specified whether the expression condition is included within an input range of the software.
